(19) United States
(12) Patent Application Publication
(10) Pub. No.: US 2021/0120839 A1
(43) Pub. Date: Apr. 29, 2021

(54) LOW-GLUCOSE-INCREASE CHOCOLATE CONFECTION

(71) Applicants: Frederick Timothy GUILFORD, Palo Alto, CA (US); Brooke SCHUMM, III, Baltimore, MD (US); YOUR ENERGY SYSTEMS, LLC, Palo Alto, CA (US)

(72) Inventors: Frederick Timothy Guilford, Palo Alto, CA (US); Brooke Schumm, III, Ellicott City, MD (US)

(21) Appl. No.: 16/605,005

(22) PCT Filed: Apr. 13, 2018
(86) PCT No.: PCT/US18/27664

§ 371 Date: Oct. 13, 2019

Related U.S. Application Data
(60) Provisional application No. 62/485,113, filed on Apr. 13, 2017.

(51) Int. Cl. A23G 1/40; A23L 27/00

(52) U.S. Cl. CPC A23G 1/40; A23L 27/86

(57) ABSTRACT

The invention proposes a solution to the problem of develop a chocolate confection that has ingredients with clinical effects, the full chocolate flavor, and minimizes or eliminates glucose increase upon consumption of a small or modest amount of the confection. The proposed solution is to use a combination of unsweetened baking chocolate, glycerin, and Readisorb® liposomally formulated glutathione available from Your Energy Systems, LLC, Palo Alto, Calif. One solution is to mix unsweetened powdered baking chocolate into Readisorb® liposomally formulated glutathione which is formulated in glycerin. The addition of stevia and a bitter blocker is also contemplated.

### TECHNICAL FIELD

The field of invention is the composition and method of manufacturing of a chocolate confection composed primarily of unsweetened baking chocolate, glycerin (also called glycerine), and liposomally formulated glutathione.

### BACKGROUND ART

For person suffering from diabetes, or who have deleterious effects from consumption of glucose or sugars, or are glucose intolerant, having a chocolate bar can be a burden requiring careful monitoring of glucose level, and potentially an injection of insulin in insulin-dependent diabetics.

A good background of the current technology can be found in Magee, Elaine, R D, M P H, “The Dieter's (and Diabetic Person's) Guide to Buying Chocolate: The ‘Recipe Doctor’ taste-tests sugar-free chocolate,” http://www.webmd.com/diabetes/features/the-dieters-and-diabetic-persons-guide-to-buying-chocolate#1, (from WebMD website) (downloaded Apr. 11, 2017):
“How Do They Make Sugar-Free Chocolate That Tastes Great?
The first thing I learned while surveying the sugar-free chocolate market was that certain drug stores and supermarkets each stock certain brands of sugar-free chocolate. So, if you're looking for a certain brand, keep going to different stores.
I also soon discovered that the sugar replacement du jour for sugar-free chocolates is maltitol (a sugar alcohol). Almost all of the companies who make sugar-free chocolates are using it.
This type of sugar replacer (which includes sorbitol, xylitol, mannitol, and isomalt, in addition to maltitol) is particularly helpful to people with diabetes because only a portion of it is digested and absorbed. And the part that is absorbed through the intestinal tract is absorbed slowly, so there is little rise in blood sugar and little need for insulin.
Sound too good to be true? Well, there are a couple of downsides to sugar-free chocolate: Potential intestinal discomfort. Most packages of sugar-free chocolate carry a label that reads” “Excessive consumption may cause a laxative effect.” This “laxative effect” is because of the part of the sugar alcohol that isn't digested or absorbed. It goes through the intestinal tract and starts to ferment and attract water. Discomfort ranging from gas to diarrhea can result, depending on the amount consumed and each person's individual intestinal tract. Consider this a little extra motivation to eat these chocolates in small portions! The American Dietetic Association advises that more than 50 grams of sorbitol or 20 grams of mannitol per day can cause diarrhea. You can find out how much sugar alcohol is in each sugar-free chocolate product by reading the nutrition information label.
Sugar-free doesn't mean saturated-fat free, or calorie-free. Chocolate tastes so good because of two things: the sweet ingredient (maltitol, in the case of sugar-free chocolate), and cocoa butter. And cocoa butter is rich in saturated fat. For example, five pieces of Russell Stover Sugar Free Chocolate Candy Miniatures add up to 190 calories, 14 grams of total fat, and 9 grams of saturated fat.”
Does Sugar-Free Chocolate Have Fewer Calories?
The good news is that there are some calorie savings with sugar-free chocolate. The bad news is that it isn't an impressive amount. A 40-gram serving of Dove sugar-free chocolate has 190 calories, and the same amount of regular milk chocolate totals around 210 calories. If this represents a daily savings of 20 calories, the weekly savings could be 140 calories, and the monthly savings, 560.
Given these calorie totals, it's important to keep portion size in mind even if you opt for sugar-free chocolate. Three pieces of the new Hershey's Special Dark Sugar Free Chocolates (24 grams weight) add up to 114 calories, 9 grams fat, 5.4 grams saturated fat, 13.8 grams carbohydrate, and 1.8 grams fiber.
While even a little calorie savings could add up for someone who enjoys some chocolate every day, the bottom line is that these new sugar-free chocolates probably are of most benefit to people with diabetes. These products could help them enjoy a little bite of chocolate without worry of it raising their blood sugar levels.”

### Id.

The potential benefits of chocolate are summarized generally as follows:
“In an Italian study published in the March 2005 issue of “The American Journal of Clinical Nutrition,” healthy subjects who consumed dark chocolate for seven days had decreased insulin resistance as well as lower blood pressure. Insulin resistance restricts the uptake of glucose into cells, which causes blood glucose levels to rise . . . . In a British study published in the November 2010 issue of “Diabetic Medicine,” diabetics who consumed chocolate high in cocoa for 16 weeks experienced a decrease in total cholesterol and an increase in high-density lipoprotein, the so-called “good” cholesterol.”
Perkins, Sharon, “Can Diabetics Eat Chocolate?,” http://healthyeating.sfgate.com/can-diabetics-eat-chocolate-5950.html (downloaded Apr. 11, 2017)

Further background is found at “Which chocolate is best for me?” [no specified author], http://www.diabetes.co.uk/food/diabetes-and-chocolate.html, Diabetes.uk.co, (downloaded Apr. 11, 2017):
“Chocolate with higher amounts of cocoa solids are best, as the sugar and fat content will often be lower as a result.
For high cocoa solids content, dark chocolate is usually a good pick.
Is diabetic chocolate better for my sugar levels?
Generally speaking, diabetic chocolate is made by replacing some or all of the sugar content with an alternative source of sweetener, such as the polyols (sugar alcohols) maltitol and sorbitol.
Polyols can have laxative effects and therefore they should not be consumed in large quantities. The effect of polyols may vary from person to person.
Some people find diabetic chocolate to be beneficial compared with regular chocolate, however, many people with diabetes find diabetic chocolate to not have enough redeeming benefits.”
The American Diabetes Association has this to say about chocolate:
“Myth: People with diabetes can't eat sweets or chocolate.
Fact: If eaten as part of a healthy meal plan, or combined with exercise, sweets and desserts can be eaten by people with diabetes. They are no more “off limits” to people with diabetes than they are to people without diabetes. The key to sweets is to have a very small portion and save them for special occasions so you focus your meal on more healthful foods.
   See more at: http://www.diabetes.org/diabetes-basics/myths/#sthash.mXlr3U8f.dpuf.”
[No author specified], “Diabetes Myths,” http://www.diabetes.org/diabetes-basics/myths/, (last reviewed Aug. 17, 2015) downloaded Apr. 11, 2017).

The problem with “sugar-free” chocolate is summarized by the advertising and warning of a manufacturer marketing under the Chocoperfection™ brand:
“Diabetic-Friendly Chocolate
When people embark on a diabetic diet, one of their most common questions is about an almost universally favorite indulgence: chocolate. It's no surprise that as people shift their dietary habits they wonder if they'll still be able to enjoy one of life's little luxuries. We have good news, straight from the experts at the American Diabetes Association:
“Myth: People with diabetes can't eat chocolate.
Fact: If eaten as part of a healthy meal plan, chocolate and desserts can be eaten by people with diabetes. They are no more “off limits” to people with diabetes than they are to people without diabetes.” (Source [citing an American Diabetes Association webpage http://www.diabetes.org/diabetes-basics/myths/])
That's where ChocoPerfection comes in. This sugar-free chocolate for diabetics is sweetened with chicory root plant fiber, which doesn't raise blood sugar levels. It's also all-natural, non-GMO, full of antioxidants, and caffeine-free. In short, this fine European chocolate will soon become one of your favorite diabetic-friendly desserts! Indulge in it after a meal or any time you need a little moment of bliss, and stay satisfied for longer not only due to the delicious taste but to the 14 grams of healthy plant fiber per serving.
You can also incorporate this diabetic chocolate into a low-carb eating program to support weight loss as you take the right steps in your diabetic lifestyle.
Having Diabetes no longer needs to feel like you can't enjoy one of the finer things in life. Support your health and indulge in a rich gourmet treat with ChocoPerfection. Order today for free U.S. shipping and a satisfaction guarantee!”
[That said, there is a warning:]
“ChocoPerfection does not contain maltitol, sorbitol, mannitol or stevia with dextrin or maltodextrin. These sweeteners are technically “sugar free” but have a glycemic index which is higher than sugar. These artificial sweeteners are not considered to be helpful for diabetics.”
https://store.chocoperfection.com/diabetic-chocolate-s/60.htm (downloaded Apr. 11, 2017).

The website continues:
“How is ChocoPerfection healthier than other sugar-free chocolate?
Aside from ChocoPerfection, all other sugar-free chocolate bars contain maltitol, an artificial sweetener that has several unhealthy side-effects. Maltitol raises blood sugar levels and does not support weight loss. Alternatively, the sweetener in ChocoPerfection is chicory root, a prebiotic fiber that has all the health benefits listed above.
Is ChocoPerfection helpful for people with Type II Diabetes?
Yes. The sweeteners in ChocoPerfection are all natural and do not have any effect on blood sugar levels. Also, each bar of ChocoPerfection also contains 56% of USDA recommended daily fiber and helps to stop cravings for sugar.”
http://store.chocoperfection.com/Health-Questions-and-Answers-a/263.htm (downloaded Apr. 11, 2017).

### SUMMARY OF INVENTION

### Technical Problem

The technical problem is to develop a chocolate confection that has ingredients with clinical effects, the full chocolate flavor, and minimizes or eliminates glucose increase upon consumption of a small or modest amount of the confection. Further, additional health benefits are needed to combat the damage caused by inflammation with respect to diabetes. Moreover, while addressing those problems, the confection needs to taste good and be of a consistency that it can be eaten comfortably and not melt or break down at room temperature. It needs to not cause stomach discomfort.

### Solution to Problem

The proposed solution is to use a combination of unsweetened baking chocolate, glycerin, and Readisorb® liposomally formulated glutathione available from Your Energy Systems, LLC, Palo Alto, Calif. One solution is to mix unsweetened powdered baking chocolate into Readisorb® liposomally formulated glutathione which is formulated in glycerin.

### Advantageous Effects of Invention

The invention achieves a combination of objectives of controlling caloric intake,

### DESCRIPTION OF EMBODIMENTS

The embodiments generally contemplate the use of solid unsweetened baking chocolate, glycerin and liposomally formulated glutathione. Powdered unsweetened baking chocolate can be used to dehydrate the glycerin. Glycerin U.S.P. is 99.5% glycerin with the rest being water. The preferred liposomally formulated glutathione is Readisorb® liposomally formulated reduced glutathione available from Your Energy Systems, LLC, Palo Alto, Calif. In each teaspoon, it contains 423 mg of glutathione. The liposomes having glutathione should have at least a 3.3% w/w concentration in the liposome. Readisorb® liposomally formulated glutathione has 8.25% w/w concentration in its liposomes. It is made from lecithin, including hydroxylated lecithin, glycerin, glutathione and has a citric flavorant and a preservative of potassium sorbate. Importantly from a caloric viewpoint, Readisorb® liposomally formulated glutathione has only about 15% glycerin in it and therefore is very low calorie. Liposomally formulated reduced glutathione should preferably be formulated with hydroxylated lecithin.

Some person are sensitive to the thiol group ion the tripeptide glutathione which can have some sulfurous smell. In one mode, the inventors propose to prepare a basic core of a) a combination of solid unsweetened baking chocolate, glycerin and liposomally formulated glutathione, or b) of solid unsweetened baking chocolate, glycerin and liposomally formulated glutathione and powdered unsweetened baking chocolate, or c) powdered unsweetened baking chocolate, glycerin and liposomally formulated glutathione, or d) powdered unsweetened baking chocolate and liposomally formulated glutathione. That core would be surrounded by a shell of a) a combination of solid unsweetened baking chocolate and glycerin, or b) of solid unsweetened baking chocolate, glycerin, and powdered unsweetened baking chocolate, or c) powdered unsweetened baking chocolate and glycerin. The mode of invention using stevia also appears to mask or reduce the odor.

Suitable ingredients and sources for them are a) Baker's™ brand unsweetened baking chocolate sold at most grocery store chains such as Giant brand grocery store operated by Ahold, b) glycerin U.S.P. which can be purchased at many drug convenience stores throughout the United States such as Rite-Aid® stores, c) baking cacao powdered unsweetened—Giant brand by Ahold (Foodhold U.S.A. LLC), and d) as referenced, liposomally formulated reduced glutathione, preferably that being Readisorb® liposomally formulated reduced glutathione sold by Your Energy Systems, LLC, 555 Bryant St., Suite 305, Palo Alto, Calif. 94301. The glycerin used was glycerin anhydrous USP 99.5%. The size of the container was 6 fluid ounces (177 ml). All temperature are in Fahrenheit unless otherwise stated. Calories are in food calories per U.S. Food and Drug Administration regulations. Without limiting the invention, the preferred size of the confection is to cut or adjust the confection resulting from the examples to a size having in the confection a quantity of Readisorb® liposomally formulated reduced glutathione of ½ tsp., 1 tsp., 1.5 tsp., 2 tsp., or 4 tsp.

### EXAMPLES

### Example 1

Using a double boiler, the water in the bottom half of the double boiler should be heated to not more than 50 degrees C. or 122 degrees F. A high grade cooking thermometer for candy is preferable. The mixing below should use constant stirring. Generally a non-stick stirring implement works best.

All of the quantities below can be scaled up; the quantities used are for illustration purposes. The suggested amounts and ratios of ingredients can be adjusted to taste.

One (1) oz. Baker's brand unsweetened baking chocolate squares is shaved to enhance even melting of the chocolate. Baker's brand unsweetened baking chocolate square (1 oz. per square-sometimes sold in 4 small ¼ oz. rectangles) has only chocolate. There is no sugar other than what little might be inherent in the cacao bean. The Baker's brand unsweetened baking chocolate square shows a serving of 2 pieces which is ½ oz. having 90 calories and 70 from fat. The fat calories are likely from the chocolate fats. The other 20 calories are presumably from other carbohydrates.

Once the double boiler or means for melting chocolate (which can be a heated ceramic or plastic board or container which is above roughly 100 degrees) (the temperature just as to be above the melting point of chocolate so it can be stirred, but governs how fast the melting occurs), the chocolate is set on the top of the double boiler or melting platform to melt. A single pan can be used, but it is harder to control the temperature. It is also necessary to be careful to avoid the edges of the double boiler where the temperature can be locally higher in the top melting pan. The temperature is important because overheated chocolate tends to streak or become granular if overheated, and the tripeptide glutathione can begin to breakdown if overheated; thus the 122 degree Fahrenheit limit on the double boiler.

One and one-half (1.5) teaspoons of glycerin is stirred into the melted chocolate, and thereafter ½ teaspoon of glycerin was added to produce a nice flavor of chocolate that is not bitter and pleasantly sweet. The glycerin can be added to taste, but if too much is added, the mixture becomes too thin to be stable as a candy bar or confection at room temperature; it becomes mushy,

Two teaspoons of the being Readisorb® liposomally formulated reduced glutathione is stirred in with another ½ oz. of the solid baking chocolate and then ¾ teaspoon more of glycerin is added, again to taste.

The product can be cooled in an ice bath by shifting the upper pan of a double boiler to another pan with ice water. After overnight refrigeration, the product is stable at room temperature as a coherent solid. Without limiting the invention, the preferred range here can be ¾ oz. of Baker's brand unsweetened baking chocolate squares, or 1 oz. or 1.25 oz. or 1.5 oz. and the preferred range of glycerin can be 0.5 tsp, 0.75 tsp, 1 tsp., 1.25 tsp., 1.5 tsp. 1.75 tsp. or 2 tsp. Without limiting the invention, the preferred range here of Readisorb® liposomally formulated reduced glutathione can be 0.5 tsp, 0.75 tsp, 1 tsp., 1.25 tsp., 1.5 tsp., 2 tsp., 2.5 tsp. or 3 tsp.

### Example 2

One oz. of Baker's brand unsweetened baking chocolate is shaved and melted in a range of roughly 116 degrees F. to 122 degrees F. by shaving.

Then that chocolate is brought to range of 114-115 degrees F. and 2 tsp of glycerin is stirred in. Thereafter, ½ tsp of unsweetened powdered baking cacao (also called Baking Cacao powdered) is added. Thereafter, one can further add to taste another ½ tsp of powdered unsweetened baking cacao.

After this, maintaining the double boiler temperature, can add 2 more oz. Baker's unsweetened baking chocolate to a total of 3 total oz. Then, as the chocolate is melting, one can add 4 tsp glycerin so there are 6 tsp total.

Then 2 tsp of Baking Cacao powdered are added to bring the mixture to 3 tsp total. The taste is good, with a good chocolate flavor and sweet enough to eliminate unpleasant bitterness. This ratio is 3 oz. Baker's solid chocolate unsweetened baking chocolate/6 tsp glycerin/3 tsp powdered unsweetened cacao. This is the “non-glutathione chocolate-glycerin mixture.”

This can be used as a coating to surround a core of a mixture of 1 oz. Baker's solid unsweetened chocolate with 2 tsp Readisorb® liposomally formulated reduced glutathione and 1 tsp of unsweetened Cacao baking chocolate powder and heated to about 95 degrees. That mixture was placed in an ice bath and partially cooled. This is and will be the “GSH core.” Then the non-glutathione chocolate-glycerin mixture is melted at 110 degree F. and used to coat the GSH core. This can be done by putting the non-glutathione chocolate-glycerin mixture on wax paper in a lump and making a dent in it or putting the non-glutathione chocolate-glycerin mixture in a mold to coat the outside of the mold, and then putting the GSH core in the coated mold or dent in the non-glutathione chocolate-glycerin mixture. Then the non-glutathione chocolate-glycerin mixture can be poured over the GSH core inside the coated mold or sitting upon the dent. Without limiting the invention, the preferred range here can be ¾ oz. of Baker's brand unsweetened baking chocolate squares, or 1 oz. or 1.25 oz. or 1.5 oz. and the preferred range of glycerin can be 1.25 tsp., 1.5 tsp. 1.75 tsp. or 2 tsp. Without limiting the invention, the preferred range in this example of unsweetened powdered baking cacao can be ¼ tsp., ⅜ tsp., ½ tsp., ⅝ tsp., ¾ tsp., ⅞ tsp., 1 tsp. or 1¼ tsp. Without limiting the invention, the preferred range here of Readisorb® liposomally formulated reduced glutathione can be 0.5 tsp, 0.75 tsp, 1 tsp., 1.25 tsp., 1.5 tsp., 2 tsp., 2.5 tsp. or 3 tsp.

### Example 3

In this example, using the same procedure of pre-heating the double boiler to 122 degrees F., 2 oz. of shaved Baker's brand unsweetened baking chocolate were melted.
1) Then 4 tsp of glycerin were measured and stirred into the melted chocolate.
2) At this point, 4 tsp of liposomal reduced glutathione (Readisorb) were stirred in with no heat to bottom of double boiler and temperature of mixture fell from 116.5 degrees to 108 degrees
3) The mixture was cooled over an ice bath and the temperature fell to 86.1 degrees F. and the taste was good with a good chocolate flavor and sweet enough to eliminate unpleasant bitterness.

This was molded by hand into a square and each ¼ of that square would have 1 tsp of Readisorb liposomal reduced glutathione.

When this was tested by a Type I diabetic doctor with experience in treating diabetes, by a finger prick, the change in glucose from prior to consumption, with finger pricks every 5 minutes to 35 minutes after consumption, the individual's blood glucose remained in a range from 168 mg/dl to 171. The limited change in blood glucose represents the small range of glucose change to be expected for a non-diabetic person after eating such a product.

Without limiting the invention, the preferred range here can be 1.5 oz. of Baker's brand unsweetened baking chocolate squares, or 2 oz. or 2.5 oz. or 3 oz. and the preferred range of glycerin can be 1.5 tsp., 2 tsp., 2.5 tsp., 3 tsp. 3.5 tsp. 4 tsp. or 5 tsp. Without limiting the invention, the preferred range here of Readisorb® liposomally formulated reduced glutathione can be 0.5 tsp, 0.75 tsp, 1 tsp., 1.25 tsp., 1.5 tsp., 2 tsp., 2.5 tsp., 3 tsp, 4 tsp., or 6 tsp.

### Example 4

In this example, 2 oz. of Baker's solid unsweetened baking chocolate was shaved and melted in the top pan of a double boiler and at a temperature of 115 degrees F., 4 tsp of glycerin were mixed in. Then, 2 tsp of powdered unsweetened baking chocolate were added to mix in. Then 4 oz. of shaved Baker's solid unsweetened baking chocolate are mixed in. Thereafter, 4 tsp of glycerin are mixed in and stirred. This had good taste with a good chocolate flavor and sweet enough to eliminate unpleasant bitterness.

Thereafter, the inventors added ¼ tsp of generic “store-brand” salt-iodized and added ⅛ tsp cream of tartar (McCormick brand) (from McCormick & Co., Inc., 211 Schilling Circle, Hunt Valley, Md. 21031).

The taste had a more lingering chocolate aftertaste with a good chocolate flavor and sweet enough to eliminate unpleasant bitterness.

Either of these formulations would be suitable for coating a core of a mixture containing the Readisorb® liposomally formulated reduced glutathione.

Without limiting the invention, the preferred range here can be 1.5 oz. of Baker's brand unsweetened baking chocolate squares, or 2 oz. or 2.5 oz. or 3 oz. and the preferred range of glycerin can be 1.5 tsp., 2 tsp., 2.5 tsp., 3 tsp. 3.5 tsp. 4 tsp. or 5 tsp. Without limiting the invention, the preferred range here of Readisorb® liposomally formulated reduced glutathione can be 0.5 tsp, 0.75 tsp, 1 tsp., 1.25 tsp., 1.5 tsp., 2 tsp., 2.5 tsp., 3 tsp, 4 tsp., or 6 tsp. Without limiting the invention, the preferred range in this example of unsweetened powdered baking cacao can be ¼ tsp., ⅜ tsp., ½ tsp., ⅝ tsp., ¾ tsp., ⅞ tsp., 1 tsp. or 1¼ tsp. Without limiting the invention, the preferred range here of Readisorb® liposomally formulated reduced glutathione can be 1.5 tsp., 2 tsp., 2.5 tsp. or 3 tsp. Without limiting the invention, the preferred range of salt can be ⅛ tsp., ¼ tsp, ⅜ tsp., ½ tsp., ⅝ tsp. or ¾ tsp. Without limiting the invention, the preferred range of cream of tartar can be 1/16 tsp., ⅛ tsp., ¼ tsp, ⅜ tsp., ½ tsp., ⅝ tsp. or ¾ tsp.

### Example 5

In this example, again, 2 oz. of Baker's solid unsweetened baking chocolate were shaved and melted by heating to 116.3 degrees in double boiler. Then, 4 tsp of glycerin was stirred in. Then 1 tsp of Giant brand powdered baking chocolate was added. Thereafter, 8 tsp of glycerin was added as the chocolate was added. This resulted in a very creamy mixture with a good chocolate flavor and sweet enough to eliminate unpleasant bitterness.

Using this mixture, the ¼ squares GSH cores from Example 3 with 1 tsp of Readisorb liposomally formulated reduced glutathione were rolled in this mixture to coat them. It was used for a taste comparison with the same mixture without a GSH core.

Without limiting the invention, the preferred range here can be 1.5 oz. of Baker's brand unsweetened baking chocolate squares, or 2 oz. or 2.5 oz. or 3 oz. and the preferred range of glycerin can be 1.5 tsp., 2 tsp., 2.5 tsp., 3 tsp. 3.5 tsp. 4 tsp. or 5 tsp. The glycerin can also range from 6 tsp., 7 tsp., 8 tsp., 9 tsp., 10 tsp., 1 tsp., 12, tsp., 13 tsp., 14 tsp., or 15 tsp. Without limiting the invention, the preferred range here of Readisorb® liposomally formulated reduced glutathione can be 1.5 tsp., 2 tsp., 2.5 tsp., 3 tsp, 4 tsp., or 6 tsp. Without limiting the invention, the preferred range in this example of unsweetened powdered baking cacao can be ¼ tsp., ⅜ tsp., ½ tsp., ⅝ tsp., ¾ tsp., ⅞ tsp., 1 tsp., 1¼ tsp, 1.5 tsp. or 2 tsp.

In examining the caloric content, per a website of Swanson Health
(https://www.swansonvitamins.com/heritage-products-vegetable-glycerin-4-fl-oz-liquid accessed Apr. 4, 2017) glycerin has about 22 calories per tsp (5 ml.) according to their FDA-required food label. Using that as a guide.
   Glycerin has 22 calories per 1 tsp. (5 ml.).
   The Baker's solid unsweetened baking chocolate package says 1 oz. had 180 calories
   The liposomal reduced glutathione composed mostly of glycerin per teaspoon has approximately 22 calories.
   If vanilla was added say 1 tsp (it was not) then the total calories might be augmented by as much as 6 cal.
   As to the Giant® brand unsweetened powdered cocoa, 1 tbsp. has 20 cal.

As the examples show, it is somewhat more difficult to create a low calorie chocolate confection using solid unsweetened baker's chocolate and glycerin as opposed to powdered chocolate.

### Example 6

This concept used the idea of mixing unsweetened powder baking chocolate into Readisorb liposomally formulated reduced glutathione.

Over a double boiler that is under 122 degrees F., 4 tbsp. of Readisorb liposomally formulated reduced glutathione would be put in. The preferable temperature is around 96 degrees F. A smaller pan was more fully immersed in the underlying bottom double boiler water. The heat was increased for the water in the bottom of the double boiler from 103 degrees F. to 109 degrees F. This was done using a simmer setting on a gas stove. The liposomal reduced glutathione was now approximately 102 to 103.6 degrees F.

At this point, 3 tablespoons of unsweetened powdered baking chocolate were added in ½ tbsp. increments. The underlying water bath was heated to 110 degrees F., and as specified always stirred. Then, two more table spoons were added of the unsweetened powdered baking chocolate in ½ tbsp. increments. The mixture had fallen to 103.7 degrees F. and was not heated to 107.1 F. The total tablespoons of unsweetened powdered baking chocolate are 5 tbsp. At about 98 degrees F., it was labeled in to 2 packages and saved in wax paper and put in the refrigerator for taste testing.

In this example 6, the calories per tsp of Readisorb liposomal reduced glutathione are based again on an approximate caloric count of 22 cal. per teaspoon (66 cal per tbsp.) of the liposomal reduced glutathione (cal.) plus a caloric count for the 5 tbsp. of unsweetened powdered baking chocolate (20 cal. per tbsp.) of 100 calories. This is 266 calories for the glycerin and 100 calories for the chocolate. Because the mixture of this Example 6 has 12 tsp. (tablespoon (tbsp.)=3 teaspoons (tsp.)) of Readisorb liposomally formulated reduced glutathione, it has the advantage of only approximately 22.3 calories per the required portion of the mixture to be equivalent to one tsp. of liquid Readisorb liposomally formulated reduced glutathione. A person would obtain 2 tsp. of Readisorb liposomally formulated reduced glutathione from a typical two portions of this chocolate confection and only obtain about 46 calories.

A typical candy bar, say a Hershey's® brand milk chocolate bar of 1.55 oz. would have 220 calories in the package. https://www.hersheys.com/en_us/products/product/bars/hersheys-milk-chocolate-bar-1-point-55-ounce-bars.html (downloaded on Apr. 12, 2017). A Ghirardelli® Chocolate Intense Dark Bar, Twilight Delight 72% Cacao, 3.5-Ounce Bars, is said to have 2.5 servings per package and each serving is 200 calories. https://www.amazon.com/Ghirardelli-Chocolate-Intense-Twilight-3-5-Ounce/dp/B0019ZHU2Q/ref=sr_1_6_s_it?s=grocery&ie=UTF8&qid=1492025958&sr=1-6&keywords=dark+chocolate+candy+bars.

In this example, the same steps can be used to mix unsweetened powdered baking chocolate into glycerin. That mixture has a low caloric content. The mixture of Readisorb liposomal reduced glutathione and unsweetened powdered baking chocolate can be covered by a thin coat of this later mixture of unsweetened powdered baking chocolate mixed into glycerin.

Without limiting the invention, the preferred range for this example of Readisorb® liposomally formulated reduced glutathione can be 1.5 tbsp., 2 tbsp., 2.5 tbsp., 3 tbsp., 4 tbsp., 5 tbsp., 6 tbsp., 7 tbsp. or 8 tbsp. Without limiting the invention, the preferred range in this example of unsweetened powdered baking cacao can be 3 tbsp., 4 tbsp., 5 tbsp., 6 tbsp., 7 tbsp., 8 tbsp., or 9 tbsp.

Another mode of invention combines into the previously described embodiments stevia, aspartame or a low calorie sweetener such as Trulia® sweetener, distributed by Cargill, Inc. of Minneapolis, Minn., US (all referred to generally as artificial sweetener”). An additional mode of invention combines a bitter blocker.

As an example, an additional mode of invention is to combine 8 tablespoons of dark chocolate powder into 4 teaspoons of glutathione by heating the mixture to a temperature not more than and preferably between 104 degrees F. and 108 degrees F. Then one packet of Trulia® artificial sweetener is combined into the mixture. Each packet contains 3 grams or 0.106 oz of sweetener. However, mixing to taste is partially dependent on the perceived bitterness of the dark chocolate. Another product is steviol glycosides with rebaudioside A and stevioside as the principal components referenced in FDA GRAS Notice GRN No. 516 available through Almenda (Thailand) Limited, Amata City Industrial Estate, 7/313\hat{ }, Tumbol Maspyangporn Amphoe, Pluakdong, 21140 Thailand.

As an example, an additional mode of invention is to combine ¾ (3 ounces) of a bar of the Baker's® dark chocolate referenced above, melt it, and combine into a mixture kept at under 122 degrees F., preferably from 95-108 degrees, 4 teaspoons of glycerin and 4 teaspoons of Readisorb liposomally formulated glutathione or other liposomal glutathione formulation. Then two packets of Trulia® artificial stevia-based sweetener are combined in. ¼ tsp is added for taste purposes.

When the composition of the previous paragraph was tested by a Type I diabetic doctor with experience in treating diabetes, by a finger prick by him, the change in glucose from prior to consumption, with finger pricks every 5 minutes to 35 minutes after consumption was essentially no change from 107 mg/dl.

The Trulia sweetener can be mixed into the glycerin before it is added to the mixture. The artificial sweetener Trulia, or other sweeteners can be in a range to taste including the amounts of 1 g, 2 g, 3 g, 4 g, 5 g, 6 g, 7 g, 8 g, 9 g, 10 g, 11 g, 12 g or more.

The Trulia brand sweetener is gluten free and has erythritol, stevia leaf extracts and natural flavors and is “kosher.”

All of the above examples were tasted without stomach discomfort.

An additional mode of invention is to combine a bitter blocker. A bitter blocker is designed to block a potential bitter aftertaste that some experience from stevia. Examples of bitter blockers that can be mixed to taste are Adenosine 5′ monophosphoric acid and its monosodium and disodium salts per FDA GRAS Notice GRN No. 144 sold by Linguagen of 2005 Eastpark Blvd., Cranbury, N.J. 08512, Clear Taste™ produced by Myco Technology found at mycotechcorp.com, 3155 N. Chambers Rd, Suite E, Aurora, Colo. 80011, and products GV3616 and GV 3717 from Givaudan Flavors Corporation with offices at 245 Merry Lane, East Hanover, N.J. 07936 (any one of which is a “bitter blocker.

The amount of bitter blocker is simply mixed to taste depending on the intensity, amount and type of chocolate, and the amount of glycerin and artificial sweetener used.

Other Formulations

As referenced previously, additional flavor enhancers can be added such as salt and cream of tartar. Also, a chicory flavor and vanilla flavor can be utilized. The vanilla can be extracted from vanilla beans by glycerin. Polypropylene glycol can be used in combination with glycerin for the vanilla bean extraction, but for persons who prefer a more organic food aspect, only glycerin would be preferable for the vanilla extraction. For those who have no preference and do not object to vanilla extract in ethanol, that can be used as a flavorant to taste. Vanilla extract in the U.S. in required to have at least 35% ethanol in order to be called vanilla extract. A vanilla flavor can be developed and called as such if extraction is by glycerin. Without limiting the invention, vanilla as vanilla extract, or vanilla as extracted above, including by glycerin, would be added to preferred taste in an amount in a range of ¼ tsp. to 2 tsp. per the amount of chocolate: i.e. per ⅓ tablespoon (15 ml.). or teaspoon (5 ml.) of powdered unsweetened baking chocolate or per 1 oz. of solid unsweetened baking chocolate.

Salt has the somewhat counterintuitive effect of bringing out the sweetness of the composition and functions as a flavor enhancer.

The inventors found cream of tartar as a flavor enhancer has the effect of prolonging the chocolate flavor.

To prevent auto-oxidation of the glutathione and preserve freshness, the confection can be packaged with nitrogen.

### INDUSTRIAL APPLICABILITY

The composition, and method of manufacturing the composition, are useful as a healthy confection and food item for human consumption and consumption by some animals.

The invention is meant to cover equivalents, and the examples above are not exhaustive of how to mix the ingredients and the quantities to be used, particularly to suit taste and desired consistency. The invention is scalable up or down in quantities. The invention includes mixing by a combination or permutation of steps above. These variations would be known to a person or ordinary skill who worked in the confectionary field.

I claim:

1. A low-glucose-increase chocolate confection composition comprising:
liposomally formulated reduced glutathione, unsweetened solid baking chocolate and glycerin.

2. The claim according to claim 1, further comprising:
an artificial sweetener.

3. The claim according to claim 2, further comprising:
stevia.

4. The claim according to claim 3, further comprising:
a bitter blocker.

5. The claim according to claim 2, further comprising:
stevia and a bitter blocker.

6. A low-glucose-increase chocolate confection composition comprising:
liposomally formulated reduced glutathione, unsweetened powdered baking chocolate and glycerin.

7. The claim according to claim 6, further comprising:
an artificial sweetener.

8. The claim according to claim 7, further comprising:
stevia.

9. The claim according to claim 8, further comprising:
a bitter blocker.

10. The claim according to claim 7, further comprising:
stevia and a bitter blocker.

11. A low-glucose-increase chocolate confection composition comprising:
liposomally formulated reduced glutathione formulated from lecithin, wherein the reduced glutathione included inside the liposome is in an amount of at least 3.3% w/w, and said liposomally formulated reduced glutathione is formulated with glycerin, solid baking chocolate, and unsweetened powdered baking chocolate.

12. The claim according to claim 11, further comprising:
an artificial sweetener.

12. The claim according to claim 12, further comprising:
stevia.

13. The claim according to claim 13, further comprising:
a bitter blocker.

14. The claim according to claim 12, further comprising:
stevia and a bitter blocker.

15. A method of manufacturing a low-glucose-increase chocolate confection comprising the following step:
mixing the ingredients of liposomally formulated reduced glutathione, unsweetened solid baking chocolate and glycerin at a temperature of less than 50 degrees C.

16. The method according to claim 15, further comprising:
mixing in said confection an artificial sweetener.

17. The method according to claim 16, further comprising:
mixing in said confection stevia.

18. The method according to claim 17, further comprising:
mixing in said confection a bitter blocker.

19. The method according to claim 16, further comprising:
mixing in said confection stevia and a bitter blocker.

20. A method of manufacturing a low-glucose-increase chocolate confection comprising the following steps:
mixing unsweetened powdered baking chocolate into liposomally formulated reduced glutathione formulated from lecithin, wherein the reduced glutathione included inside the liposome is in an amount of at least 3.3% w/w, and said liposomally formulated reduced glutathione is formulated with glycerin, said mixing to occur at a temperature of less than 50 degrees C.

21. The method according to claim 20, further comprising:
mixing in said confection an artificial sweetener.

22. The method according to claim 21, further comprising:
mixing in said confection stevia.

23. The method according to claim 22, further comprising:
mixing in said confection a bitter blocker.

24. The method according to claim 21, further comprising:
mixing in said confection stevia and a bitter blocker.
